(19) United States
(12) Patent Application Publication
(10) Pub. No.: US 2020/0051463 A1
(43) Pub. Date: Feb. 13, 2020

(54) INTELLIGENT ADVERTISING INSERT METHOD, SYSTEM, AND APPARATUS

(71) Applicant: AVERY DENNISON RETAIL INFORMATION SERVICES, LLC, Mentor, OH (US)

(72) Inventor: Francisco Duarte Barbosa Teixeira E Melo, Baiona (ES)

(21) Appl. No.: 16/538,214

(22) Filed: Aug. 12, 2019

Related U.S. Application Data
(60) Provisional application No. 62/717,333, filed on Aug. 10, 2018.

(51) Int. Cl. G09F 3/00; G09F 3/10; G09F 1/04; G06Q 30/02

(52) U.S. Cl. CPC G09F 3/0297; G06Q 30/0276; G09F 1/04; G09F 3/10

(57) ABSTRACT

A method and system for providing a printed advertisement with targeted information for the recipient of the advertisement. The printed advertisement could be made in a variety of formats and include an intelligent label or printed intelligent circuit. Thus, upon receiving the printed advertisement, the recipient could be provided with tailored or customized information directed at the recipient individually, at certain demographics, or based on certain geographic regions, for example. As a result, recipients could benefit from more relevant information and advertisers and brands from greater viewership and increased revenues.

### CROSS REFERENCE TO RELATED APPLICATIONS

The present application claims priority to and the benefit of U.S. provisional patent application No. 62/717,333 filed Aug. 10, 2018, which is incorporated herein by reference in its entirety.

### FIELD OF THE INVENTION

The present application relates generally to targeted advertisements, and more specifically to intelligent advertisements containing smart elements encoded with information targeted to one or more specific recipients.

### BACKGROUND

Advertising has existed in a variety of forms for a long time in order to promote products, services, ideas, performances, and the like. One goal of advertising is to make viewers aware of the advertisement in such a fashion that additional interest and/or sales are generated as a result of the advertisement. A common methodology of providing advertising is through printed materials. The printed materials can be personalized for a recipient, but often are generic and widely disseminated. Methods of disseminating printed advertisements include delivery via mail, flyers, inserts in periodicals or newspapers, advertisements printed in periodicals and newspapers, and handouts.

Still other modern printed advertisements can utilize a barcode or QR code to contain or provide information relevant to the advertisement or advertiser and a different overall end use. However, like more traditional advertisements, these are difficult for the provider to personalize or otherwise direct to a more narrowly targeted group or groups of recipients.

### SUMMARY

A method and system for providing a printed notice, such as, but not limited to an advertisement with targeted information for the recipient of the advertisement. The printed advertisement could be made in a variety of formats and include an intelligent label or printed intelligent circuit. Thus, upon receiving the printed advertisement, the recipient could be provided with tailored or customized information directed at the recipient individually, at certain demographics, or based on certain geographic regions, for example. As a result, recipients could benefit from more relevant information while advertisers and brands benefit from greater viewership and increased revenue.

According to some embodiments of the present disclosure, a notice comprises a substrate with a top face and a bottom face, the substrate having at least one printed area, and at least one smart element encoded with information attached to the notice that is configured to provide information to a device upon activation. In some embodiments, the at least one printed area is located on the top face. In some embodiments, the at least one printed area is located on the bottom face. In still further embodiments, the at least one printed area is located on both the top face and the bottom face. In some embodiments, the substrate is paper or a paper-based product such as cardstock. In some embodiments, the paper is a post-consumer product. In some embodiments, the paper is recyclable. In some embodiments, the paper is a coated paper. For example, the paper may be coated by a mixture of materials, including one or more polymers. The paper coating may impart one or more qualities to the paper, including weight, increased durability or strength, surface gloss, smoothness, and/or reduced ink absorbency. In some embodiments, the notice is an advertisement; for example, a product advertisement or service advertisement. In some embodiments, the smart element is a RFID label comprising a chip and an antenna. In some embodiments, the smart element is a NFC tag. In some embodiments, the smart element is a UHF tag. In some embodiments, the information is associated with a geographic area.

According to other aspects of the present disclosure, a method of making a label to be applied to a notice comprises the steps of providing a substrate with a top face and a bottom face, printing at least one area with printed content, applying a smart element to one of the top face or the bottom face of the substrate, encoding information on the smart element, and disseminating the notice. In some embodiments, a surface area of the at least one area is less than a surface area of the substrate. In some embodiments, the smart element is a NFC tag. In some embodiments, the smart element is concealed by the substrate such that the smart element is not visible. For example, the substrate may be folded to conceal the smart element. Alternatively, the smart element may be embedded within the substrate. In some embodiments, for example, the substrate may comprise two or more layers, and the smart element may be positioned between two adjacent layers of the substrate. In some embodiments, the smart element has BlueTooth® capabilities.

The present disclosure further contemplates an intelligent advertisement comprising at least one smart element encoded with information and a substrate having a top face and a bottom face, the substrate further having at least one portion with printed content, where a surface area of the at least one portion is less than a surface area of the overall substrate. In some embodiments, the smart element is an intelligent label or a printed intelligent circuit. In some embodiments, the smart element is a smart tag comprising an inlay having a RFID chip and an antenna. In some embodiments, the antenna is on the top face of the substrate. In other embodiments, the antenna is on the bottom face of the substrate. In still further embodiments, the antenna is embedded within the substrate; for example, the substrate may comprise two or more layers and the antenna may be positioned between two adjacent layers of the substrate. In some embodiments, the intelligent advertisement further comprises one or more layers of pattern-coated adhesive applied to one or both of the top face and the bottom face. In some embodiments, the advertisement is associated with a customized website. For example, the advertisement is associate with a customized website by information encoded on the smart element. In some embodiments, the substrate has at least one perforation separating the printed content from the at least one smart element. In some embodiments, the smart element has BlueTooth® capabilities.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 shows an exemplary diagram of a printed notice with a smart element such as an intelligent label.

FIG. 1A shows a bottom face of the notice shown in FIG. 1.

FIG. 2 shows an exemplary flowchart of making, sending, and utilizing a printed notice with an intelligent label.

FIG. 3 shows an alternative embodiment of an advertisement or notice set forth presently.

FIG. 4 shows an exemplary diagram of a foldable printed notice with a smart element.

FIG. 5 shows an exemplary embodiment of a perforated printed notice with a smart element.

FIG. 6 shows an exemplary embodiment of an advertisement or printed notice comprising an adhesive and further comprising a magnet.

FIG. 6A shows an exemplary embodiment of an advertisement or printed notice comprising an adhesive, a magnet, a smart element and a perforation.

FIG. 7 shows an exemplary embodiment of an advertisement or printed notice further comprising a slider.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to one embodiment, and referring generally to the Figures, an intelligent advertisement may be shown and described. The intelligent advertisements may include printed content within at least one or more specific areas of the overall advertisement or notice and an intelligent label, which in one embodiment, includes a printed intelligent circuit. The intelligent label or printed intelligent circuit may be encoded with information that relates to an intended recipient of the advertisement or a product or a plurality of products. Encoding the intelligent label with such targeted information may advantageously result in increased viewability of the advertisement as well as increased revenue for the advertisers such as through pay per click or other compensation based methodologies that allow the advertisers to collect revenue or other benefit from the usage of the intelligent label.

Other options may include on-line package delivery notifications and advertisements where advertiser receive some revenue benefit from delivery confirmation or the like.

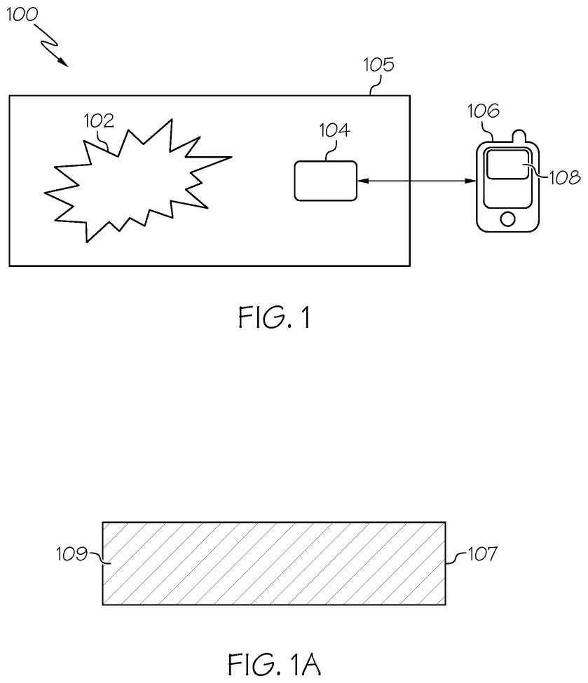

Referring now to exemplary FIG. 1, an intelligent notice such as an advertisement may be provided. The advertisement or notice 100 can be provided as a printed advertisement, for example in the form of paper, newsprint, or the like. The notice 100 may be such that it can be mailed, hand delivered, disposed or carried in a periodical, such as a magazine or newspaper, printed in a magazine or newspaper, printed on a label or adhesive shipping label, utilized as a bangtail or on a bangtail envelope, or otherwise printed and disseminated. In some exemplary embodiments, advertisement 100 could be utilized with respect to correspondence related to a recipient's mail or bills, for example, where advertisement 100 is included with mailed content in an envelope. Advertisement 100 may further include at least one area with printed content 102, such as but not limited to advertising content. Printed content 102 can be text or image data, as desired, and may be provided, orientated, and utilized in any customary manner associated with advertisements. The printed content 102 may have an area that is less than the area of the overall notice or advertisement.

The printed content 102 may be contained within a single area on intelligent advertisement 100, as illustrated in FIG. 1. Alternatively, printed content 102 may comprise printed matter located on two or more different areas of intelligent advertisement 100. For example, printed content 102 may be printed on both a top face 105 and a bottom face 107 of the intelligent advertisement 100. In some embodiments, printed content 102 is printed on a single face of intelligent advertisement 100 (such as the top face 105 only or the bottom face 107 only), but may be contained in multiple areas on that particular face of intelligent advertisement 100. For example, printed content 102 may be located on a left side of the top face 105 of intelligent label 100, as well as a right side of the top face 105 of the intelligent label 100.

In some embodiments, the printed content 102 covers a total surface area that is less than the surface area of the overall intelligent advertisement 100. Thus, in embodiments of the present invention in which printed content 102 comprises printed matter contained in two or more discrete locations, whether located on a single face or on both the top face 105 and the bottom face 107, the total surface area of such discrete locations is less than the total surface area of the intelligent advertisement 100. In other embodiments, the entire surface area of one or both faces 105, 107 of the intelligent advertisement 100 is printed with information.

In some embodiments, the smart tag is located on the top face 105 of the intelligent advertisement 100. In other embodiments, the smart tag is located on the bottom face 107 of the intelligent advertisement 100. In still further embodiments, the smart tag is embedded within the intelligent advertisement 100, between a top face 105 and a bottom face 107. The RFID chip, in some embodiments, is connected to the antenna be either direct attach methods or indirect methods. Indirect attachment methods include, for instance, using an interposer, a strap, or other connective measure.

With reference to FIG. 1A, the bottom face 107 of the intelligent advertisement 100 is shown comprising a layer of adhesive 109, which may be pattern or curtain coated. The layer of adhesive 109 may be used to secure the intelligent advertisement to various objects, including but not limited to packages, boxes, envelopes, bags, periodicals, newspapers, postcards, or consumer goods. In some embodiments (not illustrated), a smart element 104 is disposed on the adhesive layer 109 on the bottom face 107 of intelligent advertisement 100. Thus, when intelligent advertisement 100 is secured to an object, smart element 104 is contained between the object and the bottom face 107 of the intelligent label 100. Such a configuration can advantageously protect smart element 104 from damage or separation from intelligent label 100.

The present invention also contemplates that the intelligent advertisement 100 does not include a layer of adhesive 109 on a bottom face 107 thereof. In such embodiments, one or both of printed content 102 and one or more smart elements 104 may be included on the bottom face 107 of the intelligent advertisement.

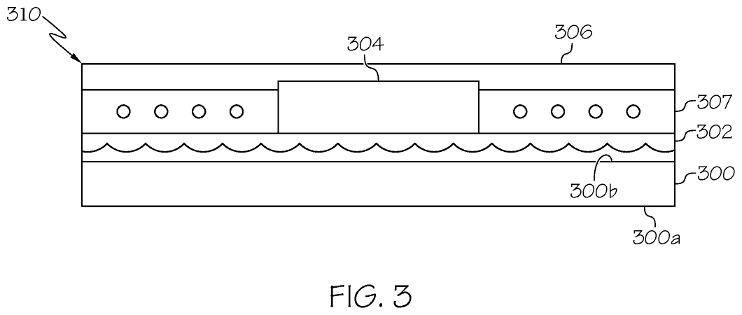

As shown in FIG. 3, the intelligent advertisement 310 comprises a substrate 300, with a bottom face 300a and a top face 300b. As illustrated, a layer of adhesive 302 may be applied on the top face 300b of the substrate 300. A smart element 104, such as an RFID inlay, may be applied to the adhesive layer 302. In some embodiments, if the smart element 304 is an RFID inlay having an antenna and a chip, the adhesive layer 302 may be in the shape of the antenna of the inlay. In some embodiments, an additional layer 306 is applied over the smart element 304, as shown in FIG. 3. The additional layer 306 presently contemplated may serve as a cover layer or protection layer and may be made by any material known in the art such as but not limited to paper, plastic (such as polypropylene, high-density polyethylene, low-density polyethylene), cardboard, etc. The additional layer 306 may overlay the smart element 304 via a second layer of adhesive 307.

In other embodiments, the configuration illustrated in FIG. 3 may be reversed such that a layer of adhesive 302 is applied to the bottom face 300a of the substrate 300, with the smart element 304 and additional layers and elements disposed thereon as described above.

In other embodiments still, substrate 300 may comprise two or more layers (not illustrated). In such embodiments, a smart element 304 may be disposed between two adjacent layers of substrate 300. Adjacent layers of the substrate 300 may be secured together by any suitable means known in the art, such as by one or more layers of adhesive.

In one embodiment of the present invention, the advertisement has a top 105 and bottom face 107. Advertisement 100 can further include at least one smart element such as, but not limited to, intelligent label, or printed intelligent circuit 104. In one embodiment, the smart element or label 104 can be a smart tag, including an inlay with a transponder, chip, and antenna on the top surface 105 of the advertisement. The chip, in one embodiment, may be connected to the antenna be either direct attach methods or indirect methods, for instance using a strap or other connective measure. FIG. 1A illustrates the backside or bottom face of the advertisement 107, which in one embodiment comprises a layer of adhesive 109 which may be pattern or curtain coated. The present invention also contemplates that the advertisement 100 contemplates that the back face 107 does not include a layer of adhesive and the label or smart element 104 may be printed or otherwise included on the backside of the label as illustrated in FIG. 3. In such an embodiment, as illustrated in FIG. 3, the advertisement 310 comprises a substrate 300, with a top 300b and bottom 300a face. As illustrated, a layer of adhesive 302 may be applied on the top face 300b of the substrate 300. An RFID inlay or other smart element 304 contemplated presently may be applied to the adhesive layer 302. In one embodiment, if the smart element 304 is an RFID inlay having an antenna and a chip, the adhesive layer 302 may be in the shape of the antenna of the inlay. An additional layer 306 may be applied, on one embodiment over the inlay. The layer presently contemplated may serve as a cover layer or protection layer and may be made by any material known in the art such as but not limited to paper, plastic (polypropylene, high-density polyethylene, low-density polyethylene, cardboard etc.). The additional layer 306 may overlay the inlay via a layer of adhesive 307, in one embodiment.

In one embodiment of the present invention, the smart element 104 may include a UPC, EPC, or other information known in the art. Label or smart element 104 can include radio frequency identification (RFID) tags, including ultra-high frequency (UHF) tags, near field communication (NFC) tags, and the like which can be printed on advertisement 100 and encoded with information relevant to the advertisement, the advertised product or service, the advertiser, the customer and/or any other subject as desired. Other frequencies could be used such as near field communication, high frequency, low frequency, BlueTooth® or other means of passive communications and/or identification.

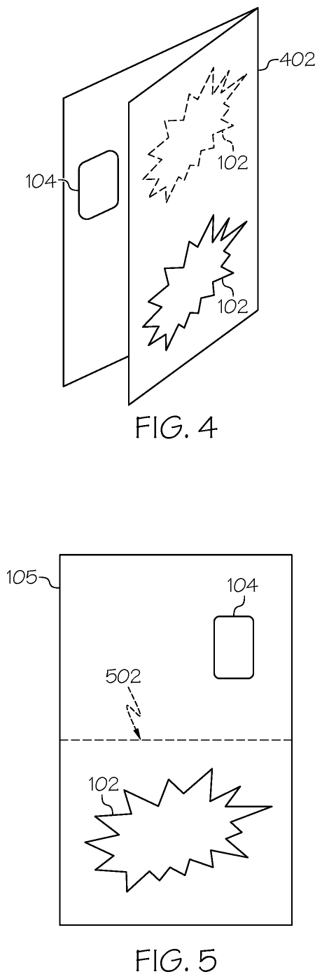

In another embodiment the advertisement 100, may be foldable, advantageously concealing or otherwise protecting the smart element 104. The folded advertisement 400 (FIG. 4) may resemble, for example, a traditional birthday or greeting card. The advertisement may have more than one fold 402. In the same context, the fold 402 of the advertisement may be a perforation 502 as can be seen in FIG. 5. Therefore, the advertisement may also have more than one perforation 502. The at least one fold 402 and at least one perforation 502 may be simultaneously utilized on the same advertisement. The perforation 502 may serve as a separator or divider between the smart element 104 and the printed content 102. This particular embodiment enables the user to clearly distinguish between “advertisement” and “smart element”. For example, if a retail store is having a sale (or other event with a deadline/termination date), half (or any other fraction of the advertisement as desired by a manufacturer) of the advertisement 100 could contain printed content detailing the events of the sale e.g. percent discounted, expiration date etc. And the remaining fraction of the advertisement may contain the smart element. Thus allowing the user to store the advertisement in one place and the smart element 104 in another place such as a purse or wallet by tearing along the perforation 502. This embodiment may be used in combination with the various combinations mentioned in the current specification.

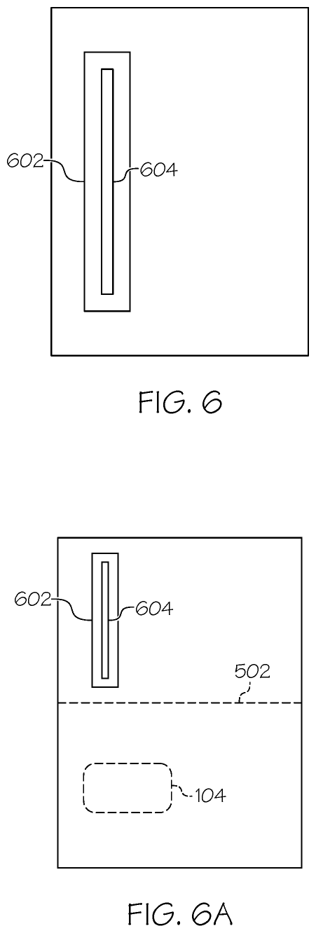

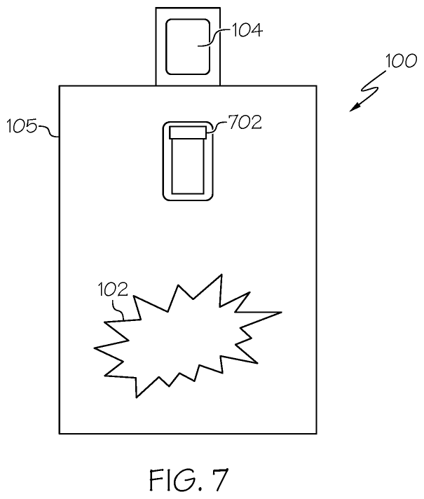

In another embodiment, the advertisement may contain an adhesive 602 used for attaching the advertisement to an object. The adhesive may create a temporary or permanent adhesion to an object. The adhesive 602 may further comprise a magnet 604. For example, in view of the embodiments described, a fraction of the advertisement may contain printed content 102 having adhesive on either its front face or back face and where another fraction of the advertisement may contain a smart element 104, where the two are separated by a perforation 502 (See FIG. 6A for an exemplary view). Furthermore, the adhesive 602 on the fraction containing printed content 102 may be a magnet 604 used to adhere part or all of the advertisement to a refrigerator for example. Thus creating a scanable advertisement located in a place a user may find convenient. The adhesive 602 may be pressure sensitive adhesive, a glue, double sided tape (having one side concealed to protect adhesive coating), tape, or another type/form of adhesion known. This embodiment may be used in combination with various embodiments within this specification.

In yet another embodiment of the advertisement 100, the smart element 104 may be temporarily concealed within an opening of the advertisement 100. For example, the smart element 104 may be an RFID or smart label that may be housed within an opening of the advertisement 100, and accessed through a sliding motion of a slider 702. As the sliding motion is initiated, the smart element 104 (smart label or RFID portion) may become separated from the body of the advertisement 100.

Further, in some embodiments, smart element 104 may be of substantially insignificant weight, as compared to advertisement 100 so that if advertisement 100 is mailed or shipped, for example, smart element 104 will not result in additional mailing or shipping fees for advertisement 100.

For example, the weight of the smart element 104 alone may be approximately half of the weight of the advertisement 100 without smart element 104. In some embodiments, the weight of the smart element 104 alone is approximately a quarter, approximately a tenth, approximately a fifth, approximately one percent, or less than one percent of the weight of the advertisement 100 without smart element.

Further, in some embodiments, although antenna and chip components of smart element 104 may or may not be visible to a recipient of advertisement 100, an area on advertisement 100, such as printed content 102, may be provided with indicia indicating to a user that additional content is available from such a smart element 104. As it may be possible to activate smart label 104 with a scanning devices, such as a smartphone, placed within a range of, for example, several inches to several feet away, advertisement 100 may not need indicia directing a recipient to scan a certain or specific area, unlike traditional barcodes or QR codes.

Smart element 104 may be encoded with any desired information. For example, smart element 104 may be encoded with information related or targeted to a specific recipient or group or recipients, of advertisement 100, a demographic group associated with advertisement 100, a geographic area associated with the delivery, display, or deployment of advertisement 100, or other specific or targeted information. In other exemplary embodiments, label 104 may be encoded with information related to the content of advertisement 100 or other content, as desired, without reference to a recipient or other targeted group.

In one embodiment, the smart element 104 may be encoded with desired information, such as, for example, a coupon code for the recipient. Such a smart element 104 may be used in combination with the other embodiments mentioned and may be create a scannable/readable advertisement. The coupon code may be a unique coupon code specifically assigned to the recipient. The coupon code may be revealed and activated when the encoded label 104 is scanned or read.

In some embodiments, additional security questions may be required upon scanning the label 104 to obtain the coupon code via a smartphone software application (“app”) or website associated with the encoded information. This will ensure that the intended customer is the user of the coupon code. The encoded information may have a terminal date or expiration date where it may be used. For example, if the encoded information is a coupon code with an expiration date of Jan. 1, 2020, then the app or website may return a message or screen informing the user of the coupons expiration on Jan. 2, 2020 and disallow a user to use redeem the coupon. As a user scans the label 104 on the advertisement 100 using smartphone 106 (or another device, such as a tablet), data pertaining to that customer's engagement may be recorded on a server or data hosting system. Thus providing a company/administrator of the advertisement 100 with data pertaining to a specific customers use of the coupon e.g. what the coupon was used on, when it was used, who used it, tracking and other analytic data may be generated.

A person of ordinary skill in the art will understand that smart element 104 may be printed on advertisement 100 at the time of printing content 102, before printing content 102, or after printing content 102, as desired. For example, label 104 may further be printed in known manners associated with the printing of, e.g., RFID, UHF, and NFC tags, antennas, and labels.

A person Label 104 may be encoded at any time. In some exemplary embodiments, label 104 may be encoded at a time prior to the sending, mailing, or shipping of advertisement 100. For example, label 104 may be encoded as a result of a trigger that occurs in the process of making advertisement 100. In some embodiments, the trigger may occur after content 102 is printed and may be associated with information regarding the recipient of advertisement 100, as noted above. Exemplary embodiments of a trigger that are utilized to encode label 104 include, but are not limited to, PIC NFT TOTAL, NFC, and UHF. In one example, after advertisement 100 is printed and labeled with the name and address of a recipient, label 104 may then be encoded to contain information specific about the recipient of that advertisement 100. Such information could include access to a digital advertisement or website customized with the name or any other information about the recipient, access or tailoring of content on a smartphone software application (“app”), or other dynamic or tailored content. Other encoded content that may be included could relate to sales information located within a specified geographic proximity to the recipient, time sensitive sales information, or other information more specifically related to the recipient, such as account information, past correspondence information, and the like.

Upon receipt of advertisement 100, or at any time thereafter a recipient may scan label 104 using smartphone 106 (or another device or smart devise, such as a tablet) to display content 108 on smartphone 106 (or another device). For example, the recipient may use appropriate software and hardware on smartphone 106 to scan label 104. The recipient may then be directed to, for example, a specific URL or app, to download, access, or otherwise obtain the subject of the information encoded content on label 104. The recipient may then browse, review, or otherwise utilize the content.

It is envisioned that advertisement 100 according to the various embodiments disclosed herein may advantageously result in greater views and returns than traditional advertisements. Further, advertising tracking and analytic data can be generated as a result of advertisement 100. Such tracking and analytic data can allow for still further revising of content associated with label 104, increased sales rates and revenue for such advertisements, data collection on recipients of advertisement 100, and the like.

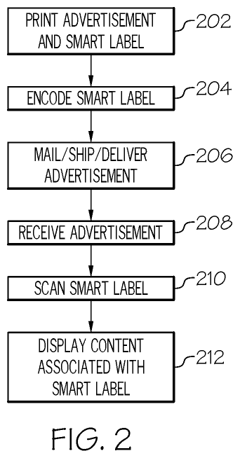

In another exemplary embodiment, a method of making and providing advertising content may be shown in FIG. 2. In 202, an advertisement may be printed with desired content and a smart element may be printed as necessary or otherwise applied to the advertisement 100. Then, in 204, the smart tag may be encoded with desired data or information, as discussed above. Alternatively, smart element may be encoded with desired data or information before being applied to intelligent advertisement. Next, in 206, the advertisement may be mailed, shipped, sent, or otherwise disseminated to an intended recipient. Upon receipt, in 208, of the advertisement, a recipient may scan the smart tag in 210, for example using a smartphone. In 212, the display of the smartphone may provide the recipient with the desired content from the smart tag or otherwise associated with the smart element, for example, content obtained from a website, database, or the like accessed as a result of scanning smart element.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A notice comprising:
a substrate with a top and a bottom face, the substrate having at least one printed area;
at least one smart element encoded with information attached to the notice that is configured to provide information to a device upon activation.

2. The notice of claim 1, wherein the substrate is paper.

3. The notice of claim 1, wherein the notice is an advertisement.

4. The notice of claim 1, wherein the smart element is a RFID label comprising a chip and an antenna.

5. The notice of claim 1, wherein the smart element is a NFC tag.

6. The notice of claim 1, wherein the smart element is a UHF tag.

7. The notice of claim 1, wherein the encoded information is associated with a geographic area.

8. A method of making a label to be applied to a notice comprising the steps of:
providing a substrate with a top and bottom face;
printing at least one area with information;
applying a smart element to the top face of the substrate;
encoding information to the smart element; and
disseminating the notice.

9. The method of claim 8, wherein the at least one surface area is less than the total surface area of the notice.

10. The method of claim 8, wherein the smart element is a NFC tag.

11. The method of claim 8, wherein the smart element is concealed by the substrate such that the smart element is not visible.

12. The method of claim 8, wherein the smart element has BlueTooth® capabilities.

13. An advertisement having at least one smart element comprising:
a substrate with a top and a bottom face having at least one area with printed content, where the area is less than the area of the overall substrate; and
at least one smart element encoded with information.

14. The advertisement of claim 13, where the smart element is an intelligent label or printed intelligent circuit.

15. The advertisement of claim 13, where the smart element is a smart tag, including an inlay with a transponder, chip, and antenna.

16. The advertisement of claim 15, where the antenna is on the top surface of the substrate.

17. The advertisement of claim 13, where the top and bottom face comprise a layer of pattern coated adhesive applied to one or both of the top face and bottom face.

18. The advertisement of claim 13, where the advertisement is associated with a customized website.

19. The advertisement of claim 13, where the substrate has at least one perforation separating desired printed content from the at least one smart element.

20. The advertisement of claim 13, where the smart element has BlueTooth® capabilities.
